(19) United States
(12) Patent Application Publication
(10) Pub. No.: US 2021/0247741 A1
(43) Pub. Date: Aug. 12, 2021

(54) FAILURE RISK-BASED PRODUCTION CONTROL METHOD

(71) Applicant: Schaeffler Technologies AG & Co. KG, Herzogenaurach (DE)

(72) Inventors: Christoph Horst, Bühl (DE); Markus Baehr, Bühl (DE); Dietmar Häckl, Bühl (DE); Daniel Lukacs, Karlsruhe (DE)

(73) Assignee: Schaeffler Technologies AG & Co. KG, Herzogenaurach (DE)

(21) Appl. No.: 16/972,812

(22) PCT Filed: May 24, 2019
(86) PCT No.: PCT/DE2019/100457

§ 371 Date: Dec. 7, 2020

(30) Foreign Application Priority Data
Jun. 14, 2018 (DE) 10 2018 114 228.5
Jul. 13, 2018 (DE) 10 2018 116 964.7

(51) Int. Cl. G05B 19/418; G06N 7/00; G05B 23/02

(52) U.S. Cl. CPC G05B 19/4184; G05B 2219/31395; G05B 23/0235; G06N 7/005

(57) ABSTRACT

A method for production control, in particular for production control used in the production of components, is based on a failure risk.

### CROSS-REFERENCE TO RELATED APPLICATIONS

This application is the U.S. National Phase of PCT Appln. No. PCT/DE2019/100457 filed May 24, 2019, which claims priority to DE 102018116964.7 filed Jul. 13, 2018 and to DE 102018114228.5 filed Jun. 14, 2018, the entire disclosures of which are incorporated by reference herein.

### TECHNICAL FIELD

The disclosure relates to a method for production control in the production of components.

### BACKGROUND

Such a method is known for example from IN201621014186A.

Components, for example components of mechatronic systems, for example automated clutch actuation systems, are developed and produced from a certain complexity of the components in a hierarchy of different responsibilities, for example customer/system/subsystems/components/subcomponents/suppliers. The requirement management being consistent across all hierarchy levels is important. This means that compliance with each requirement at a hierarchy level must be ensured by requirements at the hierarchy levels therebelow.

As a general rule, requirements at a hierarchy level should be independent of one another and should be limited to the essentials (“atomicity”). In addition, compliance with each requirement must be verifiable (“testability”) and the requirement must be traceable (“traceability”).

It is known that the development of mechatronic systems mainly has arithmetic requirements, which means that the input variables must fall between two fixed limits and deviations are not permitted. In this case, this ensures that the resulting output variables or system variables are within specific limits.

Here is a simplified example: “The transmission of the nominal torque in a component, for example a clutch actuation system, must be guaranteed.” To ensure that arithmetic requirements are met, the most critical cases for the requirement must be combined in the design and dimensioning, although this combination may be unlikely to occur. Interpretations of this type can lead to excessive reliability (“over-engineering”), and the larger the hierarchy of responsibilities, or the longer the calculation chain, or the larger the number of input variables for the calculations, the more this is likely to be the case. It is also not clear how much reliability is included in the requirement.

Features of arithmetic requirements and the temporal development thereof can be monitored in production in real-time. Violations of lower and upper limits for the feature can be displayed as an alarm and prompt an intervention in the production. Methods also exist that monitor the course of the production features and generate warnings in the event of certain abnormalities before a possible violation of the limits actually occurs. One example is the “Eight Tests for Special Causes”, which are more interested in the causes of deviations and not in the effects of the deviations on the later product.

It is known to use Monte Carlo calculations when using statistical distributions. A large number of system calculations are carried out with (pseudo)randomly distributed input variables, wherein the distributions of which correspond to the required distributions. It should be considered that to obtain a sufficiently high level of accuracy of the calculated failure probability, it must be calculated often enough that a statistically sufficient number of calculation results fail. This results in a very high computing effort for small required failure probabilities.

If a current distribution deviates from the required distribution of the input variable when this calculation method is used in production control a case that always occurs with empirical distributions a Monte Carlo calculation would need to be carried out to determine the impact on the failure probability with the real distribution. A quick and simple production control would not be possible.

It is also known that a statistical requirement, according to which an input variable should correspond to a given probability distribution, can be tested for compliance with the aid of standard tests (e.g., Kolmogorov-Smirnov test). However, only an equality is assessed here, which would be supercritical in the case of statistical requirements and therefore not helpful.

### SUMMARY

It is desirable to propose a method for production control which enables simple and timely, in particular in real-time, monitoring and evaluation of deviations, in particular statistical deviations, in input variables in production.

A further object is to meet the following requirements:

### a) Atomicity

### b) Consistency

c) Traceability: The reliability must be visualizable
d) Verifiability: It must be possible to test the requirements “in real-time” without great computational effort.

Accordingly, a method for production control, in particular for production control in the production of components, is characterized in that the method is based on a failure risk, wherein the failure risk P(failure) of at least one input variable x₁∈U₁ influenced and randomly distributed by the production, in particular an input variable which characterizes the component is determined by at least the following steps

a) determination of a nominal probability density function fx₁ for the first input variable x₁∈U₁, in particular each further determining a nominal probability density function fxᵢ for each additional possible x₁ independently and mutually independently randomly distributed and influenced by the production input variable x₁∈E U₁, i∈{2, . . . n} and
b) one-time calculation of the failure risk P(failure, nominal) on the basis of nominal probability density functions fxᵢ and definition of a maximum threshold value Pₘₐₓ≤P(failure, nominal) for the permissible failure risk and
c) one-time calculation of a nominal pain function px₁, which depends on the input variable x₁, in particular one-time calculation of further, nominal pain functions pxᵢ and each dependent on xᵢ and
d) during production, in particular of a component causing the input variable xᵢ, repeated calculation of the failure risk P(failure) by integrating the product from the pain function pₓ₁ and the actual and current probability density function \tilde{f}xᵢ, which can deviate from the nominal distribution fxᵢ, according to the following context

P(failure)=∫_{U}_{ᵢ}\tilde{f}xᵢ(xᵢ)pxᵢ(xᵢ)dxᵢ

and
e) comparison between the calculated failure risk P(failure) and the threshold value Pₘₐₓ for the failure risk and in particular
f) evaluation of the probability density function \tilde{f}_{Xi}, in the case in which P(failure)≤Pₘₐₓ as permissible and in the case in which P(failure)>Pmax as impermissible.

On the one hand, to avoid exorbitant reliability when applying the arithmetic requirement according to the prior art, and on the other hand to take into account the increasing requirements of customers, for example cost pressure, performance increases, reduction in installation footprint and reduction in inertia, this method allows a deviation in a few cases, in contrast to the arithmetic requirements.

Here is a simplified, non-limiting example: “The transmission of the nominal torque in a component, for example a clutch actuation system, should be guaranteed in 99.99999% of cases.”

In a particularly preferred embodiment, deviations of an input variable, in particular a probability density function deviating from the nominal probability density function thereof, can be assessed for admissibility with regard to the failure risk independently of possible further input variables and the actual but permissible probability density functions thereof.

In a further special embodiment, the influence of an input variable on the failure risk is visualizable by the pain function.

In a particularly preferred embodiment, the failure risk is determined by several probability density functions fx₁, . . . fxₙ having input variables x₁, . . . , xₙ, n≥2, in particular the input variables characterizing the component. A pain function can be calculated for each input variable.

In statistical interpretations, probability distributions for the output variables can be calculated from probability distributions for the input variables. From the probability distributions for the output variables, the risk of non-compliance with the partial arithmetic statement (for example: “The transmission of the nominal torque should ( . . . ) be guaranteed.”) is calculated as a statistical requirement, which can be referred to as the failure risk.

A statistical requirement is preferably met if the failure risk is less than the accepted failure risk specified in the statistical requirement.

In contrast to arithmetic requirements, in which input variables of an interpretation are fixed to an interval and a measure of the deviation is trivial, on the one hand, input distributions, for example the probability density of an input variable, can be defined and a permitted degree of deviation from the input distribution can be specified using the method.

Using the method, deviations in an input variable in production can be monitored and evaluated simply and promptly, in particular in real-time. The evaluation criterion is the failure risk.

In a special embodiment, if the calculated failure risk P(failure) is exceeded, the failure risk information is output. Depending on the failure risk information, a notification and/or a measure, in particular an intervention in the production process, can be initiated. Depending on the failure risk information, the affected component can be identified and, if necessary, removed or destroyed.

In a further preferred embodiment, the repeated calculation of the failure risk P(failure) takes place during production, in particular in real-time.

In a special embodiment, the input variable xᵢ is a dimension and/or a characteristic curve, in particular of the component.

In a further special embodiment, a temporary exceedance of the threshold value is tolerated, in particular if the failure risk of the entire production batch is again below the threshold value.

In a preferred embodiment, the failure risk is calculated for a certain partial quantity during production or for the total quantity during production, in particular for all components since the start of production.

In a preferred embodiment, the pain function px₁ is calculated analytically or estimated by a Monte Carlo calculation.

In a special embodiment, the pain function px₁ is discretized or continuous, wherein in the case of a discretized pain function a summation is used instead of an integration to calculate the failure risk P(failure).

In a further preferred embodiment, atomized, consistent, comprehensible, and easily verifiable requirements are derived for the input variable.

### BRIEF DESCRIPTION OF THE DRAWINGS

Further advantages and advantageous embodiments result from the description of the figures and the drawings.

The method is described in detail below with reference to the drawings. Specifically:

FIG. 1: shows a nominal distribution and a discrete pain function for the input variable x₁, as well as two discrete distributions for x₁ in different production lots/batches.

FIG. 2: shows a calculated failure risk, which is the area under the curve. In the discrete case, the integral is a sum. The area under the solid curve corresponds to the failure probability permitted in the requirement (here: 6×10⁻⁶).

FIG. 3: shows exemplary real-time monitoring of the failure risk in production.

FIG. 4: shows an exemplary pain hypersurface for a two-dimensional input variable space.

### DETAILED DESCRIPTION

The pain function for the first input variable x₁∈U₁ ⊂(random variable x₁ with nominal probability distribution density function fx₁) can be the following figure:

$${px}_{1} \text{:} {U}_{1} \to [ 0 , 1 ] \\ {x}_{1} \to P ( Failure \vert {x}_{1} ) \qquad ( 1 )$$

With several statistically independent input variables x₁∈U₁⊂ [symbol] , i∈{1, . . . , n} a pain function can be introduced for each, which includes the failure probability over the respective input variable, i.e., a conditional probability.

The calculation of the pain functions (see (1)) can be complex, but only need be calculated once for a requirement level. The failure risk can then be calculated by integrating the product of pain function and distribution of an input variable (see (2) below) without great computational effort, for example using the pain function for the first input variable and the nominal distribution thereof:

P(Failure,nominal)=∫_{U}_{₁}ƒx₁(x₁)px₁(x₁)dx₁ (2)

or for a probability density function that deviates from the nominal distribution \tilde{f}x₁,

P(failure)=∫_{U}_{₁}\tilde{ƒ}x₁(x₁)px₁(x₁)dx₁ (3)

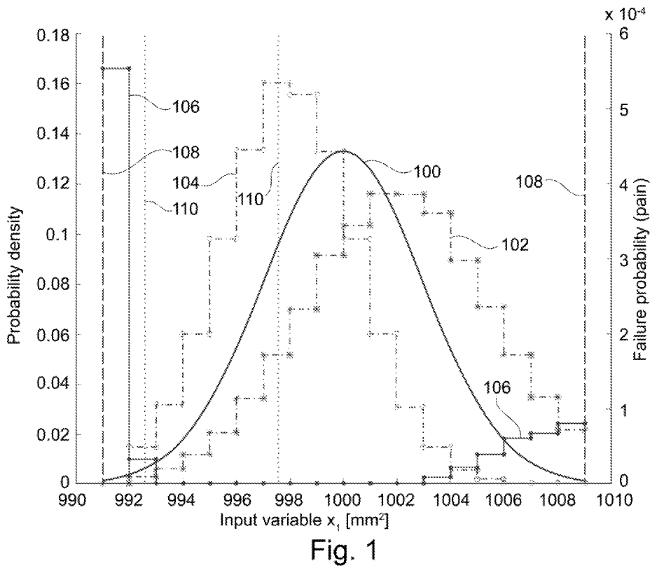

An exemplary discretized pain function and various distributions for the first input variable are shown in FIG. 1.

Various curves are given using the example of a piston surface from a clutch actuation system, in particular from a CSC. The probability density function 100 of the piston surface should be a Gaussian distribution with an average at 1000 mm² and a standard deviation of 3 mm², limited by the limits 108 at 991 mm² and 1009 mm². Deviations from this distribution 100 should be permissible if the failure risk is less than or corresponds to a predefined threshold value. The arithmetic limits 110 are given for comparison.

The following requirement can be made: The nominal probability distribution of the slave piston surface (x₁) should be given by fx₁. Deviations from this probability distribution (i.e., \tilde{f}x₁) should be permissible if the failure risk, which is calculated using the following pain function px₁, is less than 6×10⁻⁶ (Pₘₐₓ, example value).

In comparison, two actual distributions 102, 104 of the input variable are given. Also given here is the pain function 106 (here discrete) used to calculate the failure risk, to which the right-hand scale is assigned.

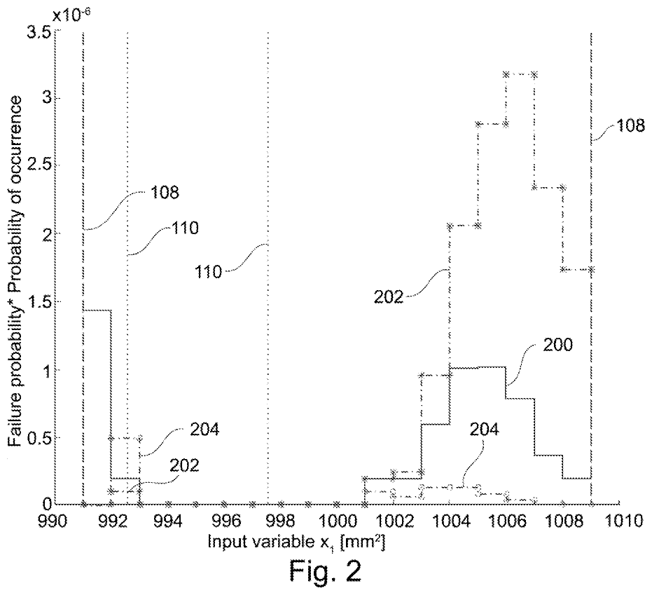

FIG. 2 shows the product corresponding to the example from FIG. 1, corresponding to the integrand according to (2) or (3). The area under the curve thus corresponds to the integral of (2) or (3), or the sum of the interval areas in the present, discrete distribution. The area under the curve 200 calculated on the basis of the nominal distribution corresponds to the failure probability permissible in the requirement, which represents the threshold value for the failure risk and in the present case is 6×10⁻⁶.

According to the curve 204, the failure risk of the batch is less than the threshold, which means that this batch is acceptable. According to the curve 202, the failure risk of the batch is higher than the threshold value, which means that this batch is not acceptable.

A statistical requirement for an input variable contains a nominal distribution 100 of the input variable, a pain function 106 for the input variable to determine the failure risk and an upper limit (here 6×10⁻⁶) for the failure risk. Distributions \tilde{f}x₁ can deviate from the nominal distribution, provided that the failure risk calculated therefrom and the pain function is less than the upper limit of the failure risk. Such deviating distributions are referred to as permissible.

\tilde{ƒ}xᵢpermissible⇔∫_{I}_{₁}\tilde{ƒ}x₁(x₁)px₁(x₁)dx₁≤Pₘₐₓ (4)

In the above case, the nominal probability distribution of the slave piston surface (x₁) is given by fx₁. Deviations from this probability distribution (i.e., \tilde{f}x₁) should be permissible if the failure risk, which is calculated using the following pain function px₁, is less than 6×10⁻⁶ (Pₘₐₓ, example value).

Atomicity is fulfilled because the failure risk is the main factor.

The upper limit Pₘₐₓ specified in a statistical requirement cannot exceed the failure probability (2), which results from the nominal distributions of all input variables in relation to the failure criterion.

A distribution \tilde{f}x₁ of an input variable that deviates from the nominal distribution fx₁ in the statistical requirement, but is permissible, leads to pain functions p\tilde{ }x₂, . . . , p\tilde{ }xₙ for the other input variables x₂, . . . , xₙ, which are equally critical or less critical than the pain functions fixed in the statistical requirements thereof. In formulas, for example, the following applies to the second input variable:

∫_{U}_{₂}ƒx₂(x₂)\tilde{p}x₂(x₂)dx_{2≤}∫_{U}_{₂}ƒx₂(x₂)px₂(x₂)dx₂=P(Failure,nominal) (5)

This ensures that the consistency and distributions of different, statistically independent input variables can be tested independently of one another. This condition is essential for a functional requirement management, especially since the input variables are generally responsible for different product lines and/or suppliers.

The criteria of testability and traceability are also met.

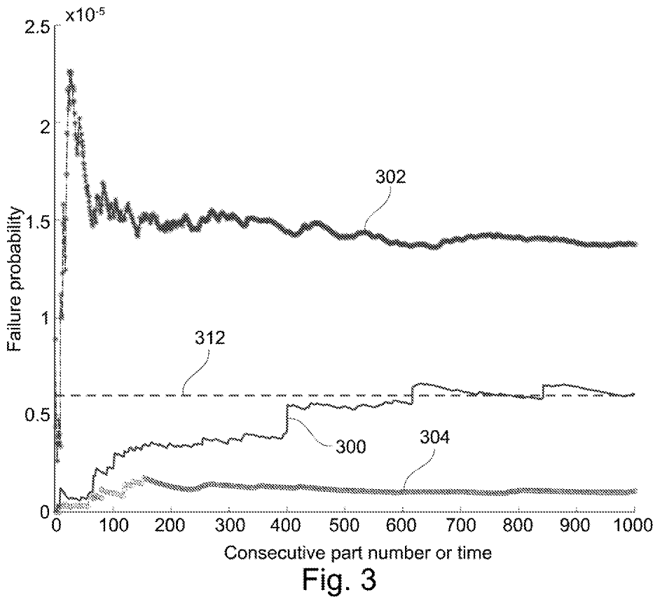

The calculation of the failure risk for a given period of time can be carried out in real-time in production, see FIG. 3. If the maximum permitted failure risk 312, here 6×10⁻⁶, is exceeded, intervention of the production process can be implemented. The failure risk of the course of the production of the batch, which is characterized by the curve 302, is above the threshold value at all times, as a result of which the batch is to be classified as not acceptable. The failure risk of the course of the production of a second batch, as illustrated by the curve 304, is lower than the threshold value, which means that this is acceptable. Analogous to the “eight tests for special causes”, an impending exceedance can be avoided. On the other hand, a temporary exceedance can be tolerated, provided the failure risk for the entire batch is again acceptable (see FIG. 3).

A batch with an impermissible failure risk can be partially released by removing a critical portion with little additional effort. The calculation and presentation of the failure risk can include the complete number of known parts (all parts since the start of production), or just a freely selectable subset. The latter can help to identify and counteract possible harmful trends at an early stage. Possible meaningful failure risks to be presented would be, for example, the failure risk of the entire quantity produced, the quantity produced since the last process intervention (for example, since changing the punching tool, since the machine tool or the like was revised), the currently running batch or the production of the last 24 hours.

A pain function can be calculated analytically in simple cases or generally estimated using methods based on Monte Carlo methods, for example.

A pain function can be defined on a continuum or in a discretized format. In the case of discretization, the integration in (2) or (3) can be traced back to a summation when calculating the failure risk (see FIGS. 1 and 2).

The accuracy of an estimation method for determining a pain function can be increased in the areas of low probability of occurrence by known methods for reducing variance (e.g., importance sampling).

The method can be used separately for various failure criteria or for the logical OR combination of various failure criteria. In the latter case, a pain function can be described as a total pain function. When designing and monitoring in production, the total failure probability resulting from the total pain function is of central importance because ultimately it is the total failures that matter. The total pain function takes into account the fact that the failure areas in the input variable space can overlap in whole or in part for various failures.

For a result variable (random variable H), which results from the input variables as follows,

h: [symbol] ⁿ⊃U₁× . . . ×Uₙ→

[symbol]

(x₁, . . . ,xₙ) [symbol] h(x₁. . . ,xₙ)=\tilde{h} (6)

and, for example, a failure \tilde{h}>hₘₐₓ the pain function can be represented analytically for the first input variable, for example:

$${px}_{1 , H , {h}_{max}} ( {x}_{1} ) = P ( \tilde{h} > {h}_{max} \vert {x}_{1} ) = {\int }_{{h}_{max}}^{∞} d \tilde{h} {\prod }_{i = 2}^{n} ( {\int }_{- ∞}^{∞} d {x}_{i} f {x}_{i} ( {x}_{i} ) ) δ ( \tilde{h} - h ( {x}_{1} , … , {x}_{n} ) ) \qquad ( 7 )$$

When combining several failures (multivariate random variable H=h₁(X₁ . . . , Xₙ), . . . , hₘ(X₁, . . . , Xₙ) with result variables

$$h : {ℝ}^{n} ⊃ {U}_{1} \times … \times {U}_{n} \to {ℝ}^{m} \\ ( {x}_{1} , … , {x}_{2} ) \to ( {h}_{1} ( {x}_{1} , … , {x}_{n} ) , … , {h}_{m} ( {x}_{1} , … , {x}_{n} ) ) = ( {\tilde{h}}_{1} , … , {\tilde{h}}_{m} ) \qquad ( 8 )$$

and failure criteria \tilde{h}ⱼ>h_{j,max}, j∈{1, . . . m} the following analytical expression results for the total pain function, for example for the first input variable:

$${px}_{1} ( {x}_{1} ) = P ( {{⩔}^{m}}_{j = 1} {\tilde{h}}_{j} > {h}_{j , max} \vert {x}_{1} ) = 1 - {\prod }_{j = 1}^{m} ( {\int }_{- ∞}^{{h}_{j , max}} d {\tilde{h}}_{j} ) {\prod }_{i - 2}^{n} ( {\int }_{- ∞}^{∞} d {x}_{i} f {x}_{i} ( {x}_{i} ) \times {\prod }_{k = 1}^{m} δ ( {\tilde{h}}_{k} - {h}_{k} ( {x}_{1} , … , {x}_{n} ) ) \qquad ( 9 )$$

Depending on the question, further logical links of different failure criteria (e.g., AND link) can be useful.

The input variables can be scalar. In the case of a non-trivial multivariate distribution on a real subset of the input variables (i.e., input variables of this subset are correlated), a pain function can be defined on this subset of the input variables. A multivariate distribution on this subset is then tested. Then a pain function on real subsets of such a subset of input variables is generally not meaningful (“over-atomicity”).

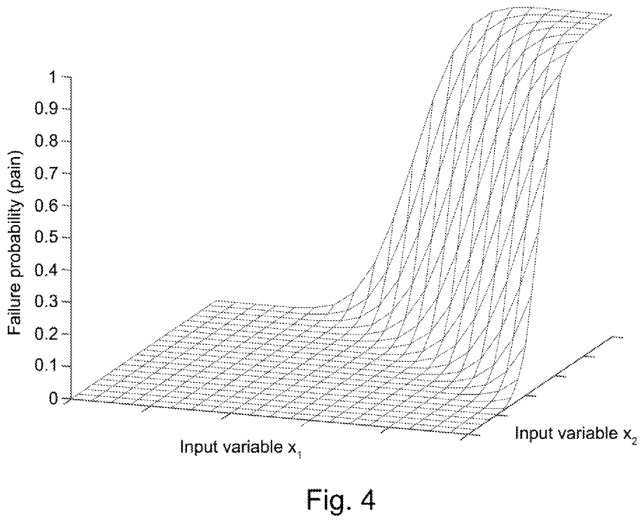

In general, pain functions in the room input variables x failure risk can be interpreted and illustrated as pain hypersurfaces (codimension 1) (see FIG. 4).

Input variables can be higher-dimensional, for example characteristic curves. In practical cases, a higher-dimensional input variable can be traced back to a subset of the n-dimensional real numbers ( [symbol] ⁿ), for example via values at reference points. In general, such a higher-dimensional input variable corresponds to scalar input variables with a multivariate distribution.

The calculation of the failure risk in production should require that the production software meets the current requirements. If the requirements change, the software should be updated in every production line (“Industry 4.0”).

1. A method for production control, in particular for production control in the production of components, wherein the method is based on a failure risk, wherein the failure risk P(failure) of at least one input variable x₁∈U₁ influenced and randomly distributed by the production, in particular an input variable which characterizes the component, is determined by at least the following steps
a) definition of a nominal probability density function ƒx₁ for the first input variable x₁∈U₁, in particular each further defining a nominal probability density function ƒx₁ for each additional possible x₁ independent and mutually independent randomly distributed and influenced by the production input variable x₁∈U₁, i∈{2, . . . n} and
b) one-time calculation of the failure risk P(failure, nominal) on the basis of nominal probability density functions ƒxᵢ and definition of a maximum threshold value Pₘₐₓ≤P(failure, nominal) for the permissible failure risk and
c) one-time calculation of a nominal pain function px₁, which depends on the input variable x₁, in particular one-time calculation of further, nominal pain functions pxᵢ and each dependent on xᵢ and
d) during production, in particular of a component causing the input variable xᵢ, repeated calculation of the failure risk P(failure) by integrating the product from the pain function pxᵢ and the actual and current probability density function \tilde{ƒ}xᵢ, which can deviate from the nominal distribution fxᵢ, according to the following context
P(failure)=∫_{U}_{ᵢ}\tilde{ƒ}xᵢ(xᵢ)pxᵢ(xᵢ)dxᵢ and
e) comparison between the calculated failure risk P(failure) and the threshold value Pₘₐₓ for the failure risk and in particular
f) evaluation of the probability density function \tilde{ƒ}xᵢ, in the case in which P(failure)≤Pₘₐₓ as permissible, and in the case in which P(failure)>Pₘₐₓ as impermissible.

2. The method according to claim 1, wherein when the calculated failure risk P(failure) is exceeded, failure risk information is output.

3. The method according to claim 2, wherein a notification or a measure, in particular an intervention in the production process, is initiated depending on the failure risk information.

4. The method according to claim 2, wherein the affected components are identified depending on the failure risk information.

5. The method according to claim 1, wherein the repeated calculation of the failure risk P(failure) takes place during production, in particular in real-time.

6. The method according to claim 1, wherein the input variable xᵢ is a number and/or a characteristic curve and/or a variable having a multivariate distribution, in particular of the component.

7. The method according to claim 1, wherein temporary exceedance of the threshold value is tolerated, in particular if the failure risk of the entire production batch is again below the threshold value.

8. The method according to claim 1, wherein the calculation of the failure risk is carried out for a certain partial quantity during production or for the total quantity during production, in particular for all components since the start of production.

9. The method according to claim 1, wherein the pain function pxᵢ is calculated analytically or estimated by a Monte Carlo calculation.

10. The method according to claim 1, wherein the pain function pxᵢ is discretized or continuous, wherein in the case of a discretized pain function a summation is used instead of an integration to calculate the failure risk P(failure).
